(19) United States
(12) Patent Application Publication
(10) Pub. No.: US 2012/0043770 A1
(43) Pub. Date: Feb. 23, 2012

(54) Safety door stopper

(76) Inventor: Wong Lau, Hong Kong (CN)

(21) Appl. No.: 13/201,620

(22) PCT Filed: May 5, 2009
(86) PCT No.: PCT/CN09/00490

§ 371 Date: Aug. 15, 2011

(51) Int. Cl. E05C 17/54

(52) U.S. Cl. 292/343

(57) ABSTRACT

A safety door stopper includes a V-shaped body and a fixed hook ,wherein the fixed hook is provided on a top edge of the V-shaped body, and two supporting plates are fixed within the V-shaped body to reinforce a supporting strength of the V-shaped body. A movable hook is connected to the fixed hook via a hinge shaft. By hanging the safety door stopper on a hinge between a door and a doorframe via the fixed hook, two plates of the V-shaped body are supporting in a gap between the door and the doorframe, so as to prevent sudden close of the door.

### BACKGROUND OF THE PRESENT INVENTION

1. Field of Invention

The present invention relates to a safety door stopper, and more particularly to a safety door stopper preventing sudden close of a door.

2. Description of Related Arts

Most of traditional door stoppers are wedge blocks. The wedge block is squeezed into a bottom of an open door to prevent sudden close. However, a gap between the door and the ground may be big or small, a height of the door stopper is not easy to be determined, besides the wedge block may be easily kicked away, so that the door is often closed suddenly, which may squeeze off children's fingers or leave the keys in the closed room, causing unnecessary trouble. A floor-supported element can also be used to attract the open door, but often resulting from a reducing force of attraction, sudden close of the door still may happen.

### SUMMARY OF THE PRESENT INVENTION

An object of the present invention is to provide a safety door stopper. The safety door stopper comprises a rotatable V-shaped body positioned by gyration between a door and a doorframe and a connecting board fixed on the door or the doorframe, so as to effectively prevent sudden close of the door and overcome disadvantages inherent in the known types of door stoppers in the prior art.

To attain this, the present invention provides a safety door stopper for supporting between a door and a doorframe, comprising a rotatable V-shaped body and a connecting board, wherein two supporting plates are connected within the V-shaped body, an hinge shaft is set on an end of the connecting board and hinged in a shaft hole set at an end of a lateral of the V-shaped body. The connecting board is connected to the V-shaped body through the hinge shaft and fixed on the door or the doorframe when in use.

Further, the present invention comprises the following:

An inside vertex angle of the V-shaped body is smaller than 90 degrees.

The V-shaped body comprises two plates having inner edges thereof connected, wherein a part of slot is opened in the inner edges, and two supporting plates in different sizes are fixed in sequence between the two plates.

The safety door stopper is made of plastic, or metal, or wood.

To attain this, the present invention provides an additional safety door stopper for supporting between a door and a doorframe, comprises a V-shaped body, two supporting plates connected within the V-shaped body and a hook on a top edge of the V-shaped body.

Further, the present invention comprises the following:

The V-shaped body comprises two plates having inner edges thereof connected, wherein a part of slot is opened in the inner edges, and two supporting plates in different sizes are fixed in sequence between the two plates.

An inside vertex angle of the V-shaped body is smaller than 90 degrees.

An additional hook is hinged on the hook.

The additional safety door stopper hangs on a hinge between the door and the door frame through the hook.

The additional safety door stopper is made of plastic, or metal, or wood.

The present invention has the following advantages: the circumstances of squeezing off children fingers or leaving keys in the closed room caused by the sudden close of the door can be avoided; the present invention is susceptible of simple structure, low cost of manufacture, being easy to be used and recycled and environmental friendliness.

### BRIEF DESCRIPTION OF THE DRAWINGS

FIG. 1 is a stereoscopic perspective view of the whole structure of the safety door stopper.

FIG. 2 is a sketch view of operation of FIG. 1.

FIG. 3 is a stereoscopic perspective view of the whole structure of the additional safety door stopper.

FIG. 4 is a front perspective view of FIG. 3.

FIG. 5 is a side perspective view of FIG. 4.

FIG. 6 is a bottom view of FIG. 5.

FIG. 7 is a sketch view of operation of FIG. 3.

FIG. 8 is a sketch view of FIG. 3 hanging on the ball-shaped door lock.

FIG. 9 is a position sketch view of the safety door stopper rotated out of the gap between the door and the doorframe when closing the door in FIG. 2.

FIG. 10 is a position sketch view of the safety door stopper rotated into the gap between the door and the doorframe when opening the door in FIG. 2.

FIG. 11 is an enlarged sketch view of FIG. 9 at an direction of A.

FIG. 12 is an enlarged sketch view of FIG. 10 at an direction of B.

In figures: 1-safety door stopper, 11-V-shaped body, 12-supporting plate, 13-edgefold, 14-shaft hole, 15-connecting board, 16-screw hole, 17-hinge shaft, 18-open-slot, 2-hinge, 3-door frame, 4-door, 5-ball-shaped door lock, 6-fixed hook, 7-additional hinge shaft, 8-movable hook.

### DETAILED DESCRIPTION OF THE PREFERRED EMBODIMENT

Further illustration of the present invention combined with figures is following.

### Embodiment 1

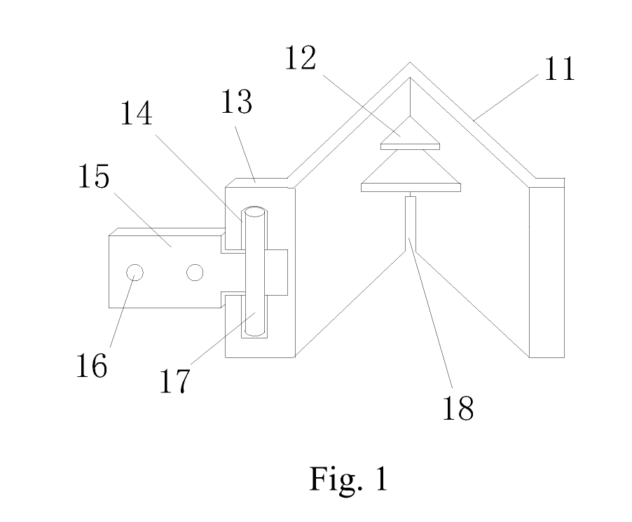

Referring to the FIG. 1, the safety door stopper 1 comprises a V-shaped body 11 and a connecting board 15, wherein the V-shaped body 11 has two plates connected via opposite inner edges and an inner vertex angle less than 90 degrees, two supporting plates 12 in different sizes are fixed in the inner gap of the V-shaped body 11 to reinforce a supporting strength thereof, a part of slot 18 is opened in the opposite inner edges of the two plates, an edgefold 13 with shaft hole 14 is set on an end of a lateral of the V-shaped body 11, a hinge shaft 17 connected to an end of a connecting board 15 rotates in the shaft hole 14, and the connecting board 15 having a screw hole 16 for fixation can be fixed on a door 4 or a doorframe 3 via screws.

The safety door stopper is similar to an A-shaped door stopper, and made of plastic, or metal, or wood, or any combination thereof.

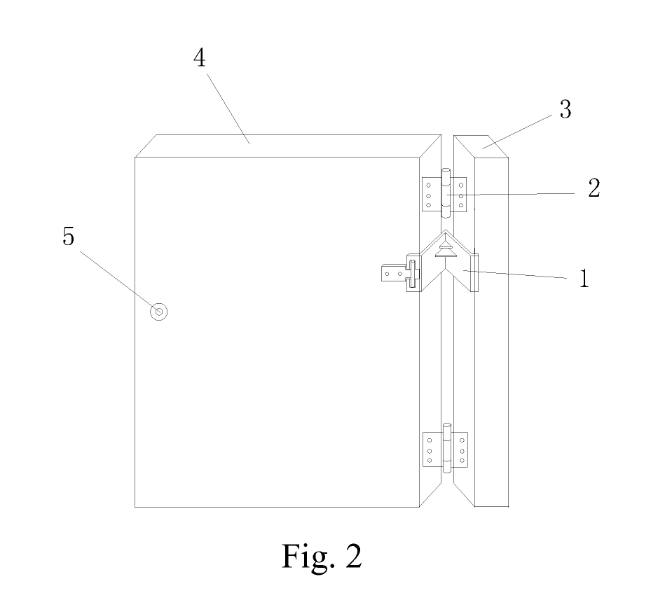

Working Principles (see FIG. 2)

When in use, the connecting board 15 is fixed on the door 4 or the doorframe 3. When opening the door 4, a gap between the door 4 and the doorframe 3 is formed. By rotating the V-shaped body 11 into the gap between the door 4 and the doorframe 3 to support between the door 4 and the doorframe 3, the door 4 can not be closed; by rotating the V-shaped body 11 out of the gap between the door 4 and the doorframe 3, the door 4 can be closed when needed.

The safety door stopper functions through rotating the V-shaped body.

### Embodiment 2

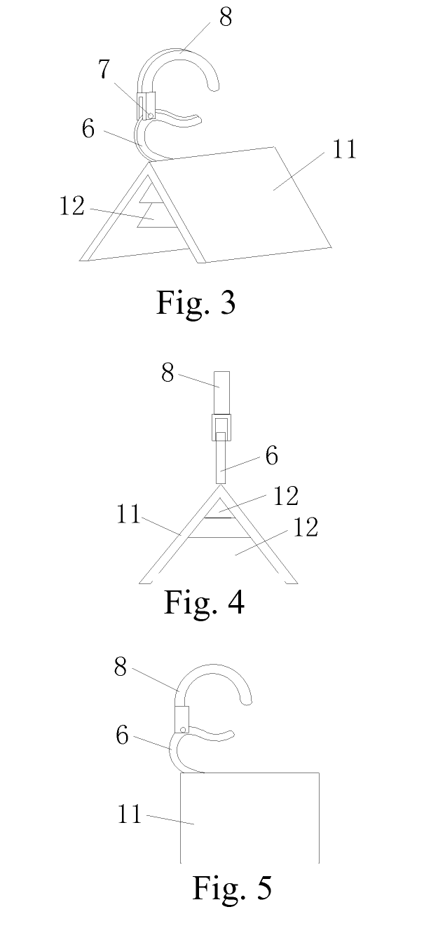

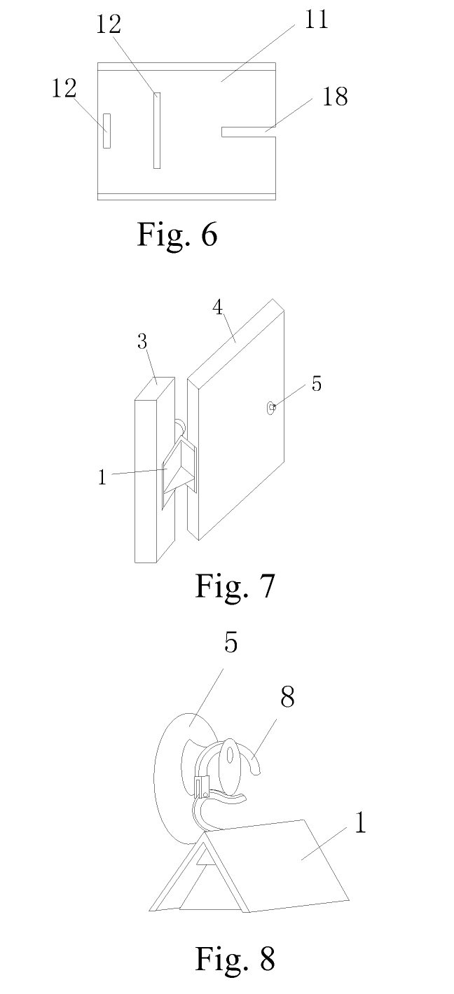

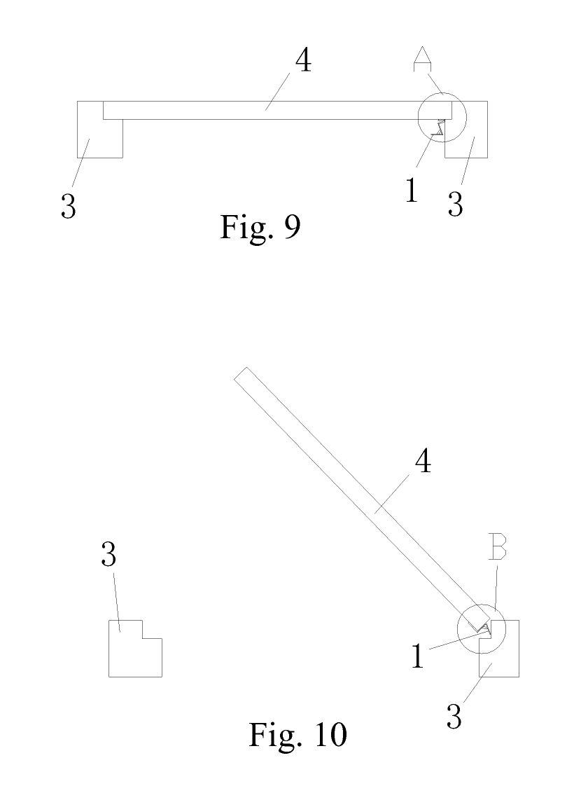

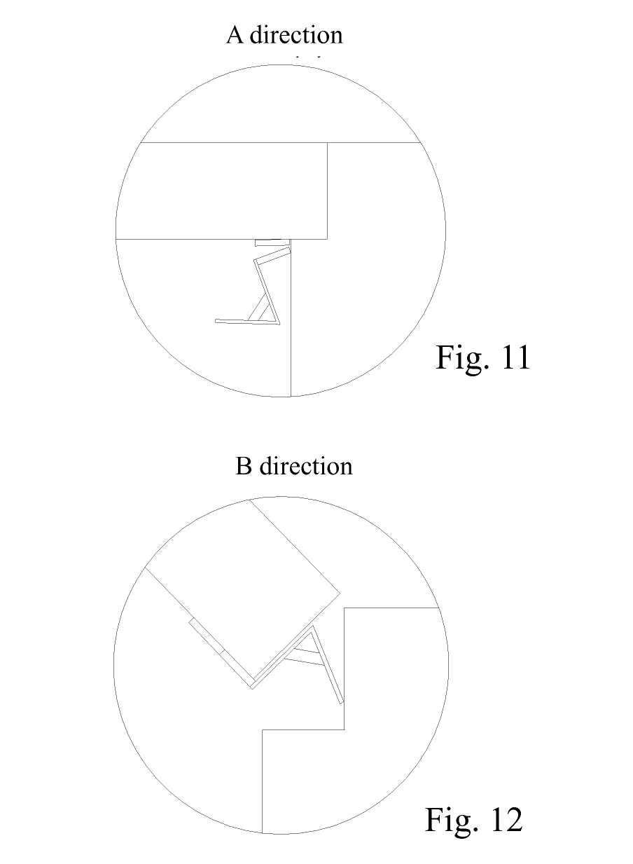

Referring to the FIG. 3, the additional safety door stopper comprises a V-shaped body 11 and a fixed hook 6. The fixed hook 6 is mounted on a top edge of the V-shaped body 11. Two supporting plates 12 are fixed within the V-shaped body 11 to reinforce a supporting strength of the V-shaped body 11. A movable hook 8 is connected to the fixed hook 6 through an additional hinge shaft 7.

The additional safety door stopper is similar to an A-shaped door stopper, and made of plastic, or metal, or wood, or any combination thereof.

The V-shaped door stopper 11 and the fixed hook 6 of the present invention are moulded through once injection of plastic.

Working Principles

When opening a door 4, a hinge 2 between the door 4 and a door frame 3 is exposed. By hanging the fixed hook 6 of the additional safety door stopper on the hinge 2, the V-shaped body 11 is in a gap between the door 4 and the door frame 3(see FIG. 7). When closing the door 4, two plates of the V-shaped body 1 support between the door 4 and the door frame 3, so that the door 4 can not be closed.

When the additional safety door stopper is not in use, the additional safety door stopper can adjacently hang on a ball-shaped door lock 5 through the movable hook 8, for a convenience of next usage.

1.-6. (canceled)

7. A safety door stopper, for supporting between a door and a doorframe, characterized in that the safety door stopper comprises a rotatable V-shaped body and a connecting board, wherein two supporting plates are connected within the V-shaped body, a shaft hole is set on an end of a lateral of the V-shaped body, a hinge shaft set on an end of the connecting board is hinged in the shaft hole of the V-shaped body, and the connecting board is connected to the V-shaped body via the hinge shaft and fixed on the door or the doorframe.

8. The safety door stopper, as recited in claim 7, characterized in that an inner vertex angle of the V-shaped body is smaller than 90 degrees.

9. The safety door stopper, as recited in claim 7, characterized in that the V-shaped body comprises two plates connected via opposite inner edges having a part of open-slot, and the two supporting plates in different sizes fixed in sequence within the two plates.

10. The safety door stopper, as recited in claim 7, characterized in that the safety door stopper is made of plastic, or metal, or wood.

11. A safety door stopper, for supporting between a door and a doorframe, characterized in that the safety door stopper comprises a V-shaped body, a supporting plate connected within the V-shaped body, and a hook provided on a top edge of the V-shaped body.

12. The safety door stopper, as recited in claim 11, characterized in that the V-shaped body comprises two plates connected via opposite inner edges having a part of open-slot, and the two supporting plates in different sizes fixed in sequence within the two plates.

13. The safety door stopper, as recited in claim 11, characterized in that an inner vertex angle of the V-shaped body is smaller than 90 degrees.

14. The safety door stopper, as recited in claim 11, characterized in that an additional hook is hinged on the hook.

15. The safety door stopper, as recited in claim 11, characterized in that the safety door stopper hangs on a hinge between the door and the doorframe through the hook.

16. The safety door stopper, as recited in claim 11, characterized in that the safety door stopper is made of plastic, or metal, or wood.
